(19) United States
(12) Patent Application Publication
(10) Pub. No.: US 2003/0068150 A1
(43) Pub. Date: Apr. 10, 2003

(54) Termination of end-faces of air-clad and photonic-crystal fibers

(75) Inventors: Yedidya Ariel, Dolev (IL); Eilon Sherman, Ramat Gan (IL); Anatoly Patlakh, Holon (IL); Rafael Bronstein, Kefar-Sava (IL)

Correspondence Address: OLIFF & BERRIDGE, PLC, P.O. BOX 19928, ALEXANDRIA, VA, 22320, US

(73) Assignee: Rayteq Photonic Solutions Ltd., Rehovot (IL)

(21) Appl. No.: 10/095,480

(22) Filed: Mar. 13, 2002

Related U.S. Application Data
(60) Provisional application No. 60/327,776, filed on Oct. 10, 2001.

(51) Int. Cl. G02B 6/20; G02B 6/00; G02B 6/26

(52) U.S. Cl. 385/125; 385/139; 385/31

(57) ABSTRACT

A method of preventing contamination of the air channels in the capillaries or pores of an air-clad or photonic-crystal fiber during polishing of the end-faces. A glass or silica fiber rod of diameter comparable to the fiber is fused to the end-face of the fiber, cut, and polished to form a thin protective plate having no appreciable affect on the optical properties of the fiber. Alternatively the air capillaries may be sealed by a UV-curable fluid or by melting the surrounding material. The end-face of the fiber thus presents a polished or cleaved surface for optical coupling to other fibers without causing damage or contamination to the air channels of the fiber. Furthermore, treating both end-faces of an air-clad or photonic-crystal fiber in manner provides a hermetic seal for the air-channels and protects the fiber against degradation caused by contamination such as humidity and dust which would otherwise enter the air channels over the course of time. Furthermore, there is a reduction in power density at the end-face of the fiber, which reduces the risk of damage. Anti-reflective coatings are consequently easier to apply and more stable. In addition to protecting the end-face of an air-clad or photonic-crystal fiber with a thin plate, it is also possible to utilize a graded-index (GRIN) element to perform both the protective function as well as an optical function.

### FIELD OF THE INVENTION

The present invention relates to air-clad and photonic-crystal fibers, and, more particularly, to methods of processing and connecting such fibers to optical transmission networks.

### BACKGROUND OF THE INVENTION

Optical fibers are used to transmit optical signals in optical communication networks. Networks typically involve large assemblies of signal souses and receivers, optical fibers transmission lines, optical switches, optical amplifiers and repeaters multiplexers and de-multiplexers, signal drop-down points, and other elements as required for efficient network operation.

In order to attain proper optical network functioning, different components of the network are connected to each other in ways that facilitate optical signal generation, transmission, and amplification without incurring excessive signal loss.

Connections between fiber lines may be of the “splice” type, where one fiber is physically fused into another fiber. This type of connection, however, does not permit the repetitive connect-disconnect operations which are required for network maintenance, expansion, debugging, or replacement of faulty components.

To allow repetitive connect-disconnect operations, optical fiber connectors are used. To minimize losses at the interface between two fibers, the end-faces of the fiber are polished during the connector assembly. For applications requiring a high degree of matching between two fiber lines, an index-matching liquid is placed in the gap between the two connecting fibers.

Conventional fibers are solid elements, and even when they are made of a number of coaxial glass cylinders, there are no voids between the glass cylinders. FIG. 1 shows a cross-section of a conventional optical fiber, with a core 30 and a cladding 32. For any fiber, to ensure total internal reflection of the propagating radiation within the fiber core, the values of refractive indices n of the core and the cladding are selected according to the inequality relation:

n_{core}>n_{cladding} (1)

Polishing the end-faces of solid optical fibers with or without a guiding ferrule is a relatively staightforward task and is well-understood in the art Methods of polishing such fibers and assembling them into connectors are disclosed in U.S. Pat. No. 4,979,334, U.S. Pat. No. 5,640,475, and U.S. Pat. No. 5,743,785.

The amount of light that may be coupled into a fiber depends on the numerical aperture of the fiber, NA, where

NA=√(n²_{core}−n²_{cladding}) (2)

For purposes of both signal transmission and signal amplification it is desired to couple as much light as possible into a fiber. Increasing the difference in refractive indices of core and cladding increases NA of a fiber and allows coupling of larger amount of light into it. Hence, fibers having multiple claddings (such as double cladding) that allow for the selection of proper refractive indices are used for these applications.

Single-mode optical signals propagate through fibers with lower losses than multi-mode signals. Fibers conducting single-mode signals have cores ranging in diameter from three to nine microns, depending on the signal wavelength. Although a small fiber may have a large numerical aperture, it is nonetheless difficult to project on the end-face of such a fiber an image of a significantly asymmetric light source having a non-negligible physical size, such as that of a laser diode used to pump optical fiber amplifiers.

Recently introduced are the so-called “air-clad” fibers, as disclosed in U.S. Pat. No. 5,907,652. Air-clad fibers have a larger numerical aperture than conventional single mode fibers, enabling higher power densities to be introduced into the fiber core. FIG. 2 shows the cross-section of a multi mode air-clad fiber 50 with a single-mode fiber core 52, an inner cladding 54, an air cladding 56, and an outer cladding 58. Air cladding 56 is made of hollow glass or silica glass capillaries with inside diameters ranging from a fraction of a micron to about four or five microns. Walls dividing the space between the air channels (or “pores”) have a typical thickness less than one micron. Fiber core 52 may be doped with rare earth elements.

Photonic-Crystal Fibers (PCF's) are air-clad fibers having air channels arranged periodically according to a grid scheme, and are described in PCT/GB00/00600 published as International Publication Number WO 00/49436, and PCT/GB00/01249 published as International Publication Number WO 00/00/60388. PCF's have properties similar to air-clad fibers and allow the transmission of even higher energy densities. FIG. 3 shows the cross-section of a photonic-crystal fiber 64 as disclosed in International Publication Number WO 00/49436. Fiber 64 has a single mode fiber core 66, a photonic-crystal structure assembled of hexagon silica glass canes. A typical hexagonal cane has a cylindrical hollow center 68 and a glass wall 70 with juxtaposed with other hexagon canes. An outer cladding 74 may reinforce the fiber structure. Hexagonal silica glass canes have inside diameters ranging from a fraction of a micron to about four or five microns. Walls between the hexagonal silica glass canes have a typical thickness less than one micron.

The term “air-clad optical fiber” herein denotes, without limitation, any optical fiber having air channels or open pores of any kind, including, but not limited to, photonic-crystal fibers.

Despite the advantages of the air clad and crystal fibers, the present inventors have realized that it is often very difficult and sometimes impossible to process them properly. During polishing, the fragile glass walls of the air cladding capillaries are easily broken. In addition, debris from the polishing process, such as slurry, particles of polishing paper, and other residuals remain in and clog the air channels or pores of the polished fiber tip. This material adversely affects the effective refractive index and significantly reduces the fiber's numerical aperture. FIG. 4 shows longitudinal cross section A-A of the air-clad fiber of FIG. 2 with a polished end-face 78 and polishing process residuals 80.

As a result of this contamination, the overall yield of polishing of such fibers is low. But even when a fiber end-face has been successfully polished and assembled into a connector and installed in the field, humidity gradually penetrates into the open air channels and pores of the fiber. Normal fluctuations in temperature accelerate this effect, with the result that the fiber quality degrades over time. Depending on the environment, the degradation may proceed at differing rates. But whether rapid or relatively slow, degrading of the fiber is inevitable.

Another major problem with air-clad and photonic-crystal fibers is encountered in high power applications, rich is a common use for such fibers. High power densities can cause burning of the fiber end-face. In addition, when coupling a high power beam through See space an “anti-reflective” coating is recommended, but air-clad and photonic-crystal fibers are hard to coat because of leakage through the air channels and the fact tat the coating itself affects fiber performance by filling the air channels.

There is thus a need for a method of processing that protects air-clad and photonic-crystal fiber end-faces without clogging of the air channels or pores caused by cleaving and polishing.

There is further a need for a high-yield method of processing air clad and photonic-crystal fiber end-faces, and there is a need for a method of reliably applying stable anti-reflective coatings on the end-faces of such fibers.

There is moreover an additional need for a method of protecting air-clad and photonic-crystal fiber air channels and pores against penetration of humidity and other contamination across the end-faces after processing, when fibers are installed in connectors in the field.

These goals are met by the present invention.

### SUMMARY OF THE INVENTION

An objective of the present invention is to provide a method of processing air-clad and photonic-crystal fiber end-faces without clogging the air channels or pores when polishing is involved.

An additional objective of the present invention is to provide a high-yield method of processing air clad and photonic-crystal fiber end-faces, and a way of reliably applying stable anti-reflective coatings on the end-faces of such fibers.

A further objective of the present invention is to provide a method of protecting air-clad and photonic-crystal fiber air channels and pores against penetration of humidity and other contamination across the end-faces after processing, when fibers are installed in connectors in the field.

The present inventors have realized that the above objectives may be achieved by hermetically sealing the air channels and pores.

Means of “seeding” include, but are not limited to: closing, capping, plugging, filling, constricting, and collapsing the air channels and/or pores. An air-clad optical fiber to which such sealing has been applied is herein denoted as 'sealed”, and sealed air-clad optical fibers include, but are not limited to, air-clad optical fibers having air-channels or pores that are closed, capped, plugged, filled, constricted, and/or collapsed. The term “air channel” herein denotes any void in an optical fiber, including, but not limited to hollow capillaries and hollow pores. The term “end-face” herein denotes the surface of either of the ends of an optical fiber, including the material of the optical fiber to a depth in which optical effects are negligible. The term “rod” herein denotes any glass or silica fiber having suitable physical and optical properties for attachment to the end-face of an optical fiber.

According to one of the exemplary embodiments of the present invention, the above objectives may be achieved by sealing the air-channels at the end-face of an air-clad optical fiber, utilizing a method which includes the steps of:

(a) forming an end-face to be sealed by cleaving the air-clad optical fiber at a predetermined location;

(b) selecting a solid glass or silica fiber rod having a diameter comparable to that of the air-clad optical fiber;

(c) splicing the formed end-face of the air-clad optical fiber to the rod to form a spliced rod;

(d) cutting the spliced rod to a predetermined thickness stable for polishing such that the spliced rod has a free end; and

(e) polishing the free end of the spliced rod to reduce the thickness such that the remaining material of tie rod forms a cap that does not substantially affect the optical properties of fiber regarding the light-coupling properties of the end-face of the air-clad optical fiber.

According to another exemplary embodiment of the present invention, the above objectives may also be achieved by sealing the air-channels at the end-face of an air-clad optical fiber, utilizing a method which includes the steps of:

(a) forming a fiber end-face to be sealed by cleaving the air-clad optical fiber at a predetermined location;

(b) penetrating the air-channels of the end-face with a polymerizable fluid

(c) sealing the air-channels of the end-face, by polymerizing the fluid that has penetrated therein;

(d) cutting the air-clad optical fiber to a predetermined size suitable for polishing; and

(e) polishing the sealed free end of the air-clad optical fiber to reduce the thickness thereof such at the remaining material of the seating does not substantially affect the optical properties of the air-clad optical fiber regarding the light-coupling properties of the sealed end-face.

According to yet another exemplary embodiment of the present invention, the above objectives may be achieved by sealing the air-channels at the end-face of an air-clad optical fiber, utilizing a method which includes the steps of:

(a) forming an end-face to be sealed by cleaving the air-clad optical fiber at a predetermined location;

(b) penetrating the air-channels of the end-face with a polymerizable fluid material;

(c) sealing the air-channels of the end-face by polymerizing the fluid that has penetrated therein; and

(d) cleaving the sealed free end of the air-clad optical fiber to a predetermined size to reduce the length thereof such that the remaining material of the sealing does not substantially affect the optical properties of the air-clad optical fiber regarding the light-coupling properties of the end-face.

According to a further exemplary embodiment of the preset invention the above objectives may be achieved by sealing the air-channels at the end-face of an air-clad optical fiber, utilizing a method which includes the steps of:

(a) forming an end-face to be sealed by cleaving the air-clad optical fiber at a predetermined location;

(b) melting the end-face by heating; and

(c) forming on the end-face a thin layer of melted fiber material to seal the air-channels of the end-face, in such a manner tat the optical properties of the air-clad optical fiber regarding the light-coupling properties of the end-face are not substantially affected.

An advantage of is last-described method is that the sealing is formed of the same material as the fiber and no additional parts, elements, or substances are used in the method. Under such conditions, the sealed end-face of the fiber may not require polishing at all.

The methods as described above provide advantages over the prior art in that the polishing of the end of the fiber is done on a section of fiber that has no air channels and hence will not be degraded by contamination due to polishing residuals, as otherwise occurs for an air-clad or photonic-crystal fiber (FIG. 4). Freedom from such contamination increases the yield of fibers made according to the present invention Also, the present invention offers another advantage in that it is possible to clean the tip of the optical fiber during maintenance without contaminating the air channels. A cotton swab wetted with a cleaning agent, such as alcohol, can be used to clean the fiber tip without leaving lint, residual mat, or other contaminants in the pores of the air channels.

An additional advantage of the invention is that tee power cross-section distribution at the end-face could extend over a much large area, thereby significantly reducing he power density at the end-face and lowering he risk of damage caused by excessive power. Moreover, anti-reflective coat are easier to apply because of the flat or curved solid surface at the end-face, with the benefit that such coatings are more stable because of the reduced power density.

A advantage is provided if a method of the present invention is performed at both end-faces of an air-clad or photonic-crystal fiber. According to the present inventions penetration of humidity, dust, and other contaminants into an air-clad or photonic-crystal fiber is prevented by treating both end-faces of the fiber in the manner described above, such that the splices between the original fiber and the rods effect hermetic seals at each end.

The present invention also provides an air-clad or photonic-crystal fiber article having a first end-face and a second end-face such that both end-faces are sealed. The sealing of the end-faces may be performed by tin optical plates spliced onto the first and second end-aces of the fiber, by UV-curable fluid drawn into the air channels by capillary effects, or by heating and melting the end-face to collapse the air channels. The above methods seal the air channels at the end-faces of the fiber and prevent the penetration of humidity and other contaminants without adversely affecting the path of light exiting or entering the fiber.

### BRIEF DESCRIPTION OF THE DRAWINGS

The invention is herein described, by way of non-limiting example only, with reference to the accompanying drawings, wherein:

FIG. 1 is a transverse cross-section of a conventional prior art optical fiber structure.

FIG. 2 is a transverse cross-section of a prior art air-clad optical fiber structure.

FIG. 3 is a transverse cross-section of a prior art photonic-crystal fiber structure.

FIG. 4 is a log cross-section A-A of the fiber of FIG. 2, illustrating a polished end-face and polishing process residuals clogging the air channels of the fiber.

FIG. 5 is a longitudinal cross-section of an exemplary embodiment of the present invention.

FIGS. 6A, 6B, and 6C are longitudinal cross-sections of a fiber and a rod illustrating steps in a method according to the present invention for fabricating a capped end-face of an air-clad or photonic-crystal fiber.

FIG. 7 is a longitudinal cross-section of a fiber according to the present invention, illustrating the beam propagation into or out of the fiber.

FIG. 8 is a longitudinal cross-section of another exemplary embodiment of the present invention.

FIG. 9 is a longitudinal cross-section of yet another exemplary embodiment of the preset invention.

FIGS. 10A, 10B, and 10C are longitudinal cross-sections of a fiber illustrating steps in a method according to the present invention for sealing the end-face of an air-clad or photonic-crystal fiber.

FIG. 11 is a longitudinal cross-section of a further exemplary embodiment of the present invention.

FIG. 12 illustrates the formation of a concave surge sealing of a fiber end-face.

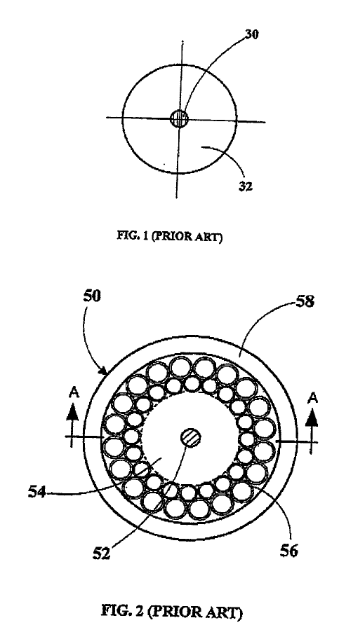

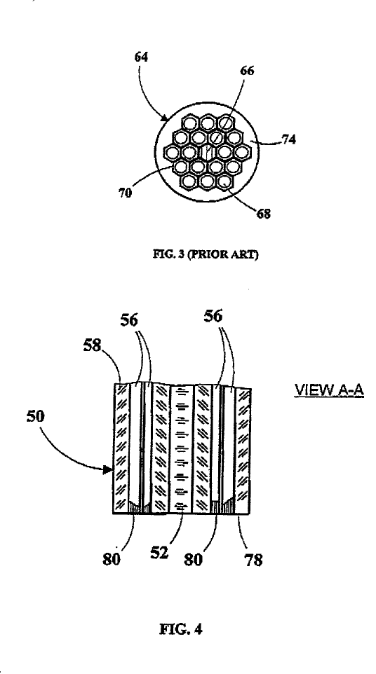

### DESCRIPTION OF THE EXEMPLARY EMBODIMENTS

The principles and execution of a method according to the present invention, and the operation and properties of a fiber produced thereby may be understood with reference to the drawings and the accompanying description of non-limiting, exemplary embodiments.

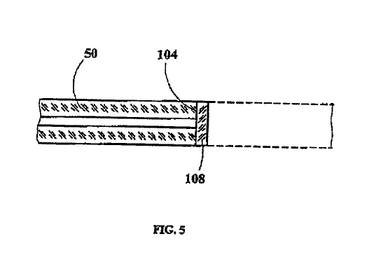

FIG. 5 is an illustration of an exemplary embodiment of the present invention showing a simplified longitudinal cross section of an air clad optical fiber 50 with an end-face 104, which is to be cleaved and polished. In accordance with the present invention, prior to polishing end-face 104, a rod 108 having substantially the same outside diameter as fiber 50, is permanently attached to fiber 50 at end-face 104. Rod 108 is cleaved and polished to a length that does not substantially affect the propagation and path of light within fiber 50, into fiber 50, or out of fiber 50.

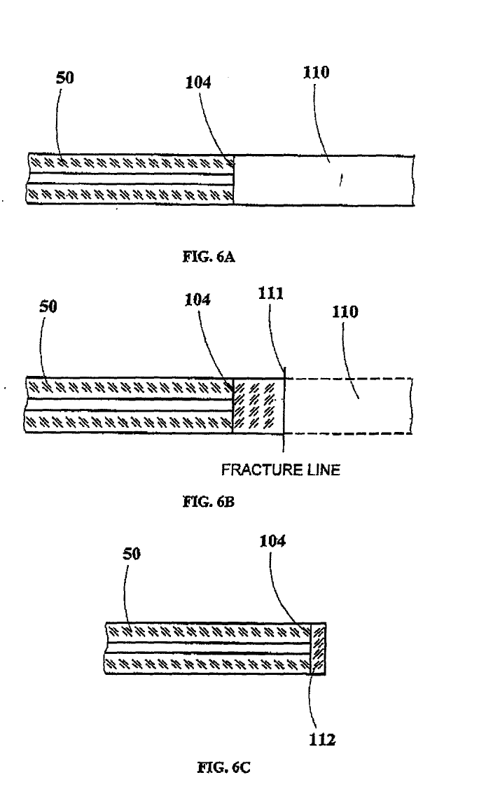

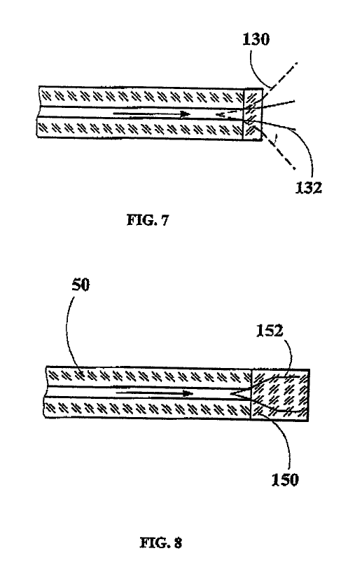

FIGS. 6A, 6B, and 6C illustrate the steps of a method of fabricating a protected end-face of an air-clad or photonic-crystal fiber 50 in accordance with the present invention. FIG. 6A illustrates the a step in which fiber 50 is cleaved and spliced to a rod 110. Any commercially available fusion splicer may be used to perform this splicing operation in accordance with well-known techniques in the art. Rod 110 may be a simple solid (neither air-clad nor photonic-crystal) drawn fiber of substantially the same diameter as fiber 50.

FIG. 6B illustrates a follow step in which rod 110 is cut or fractured on a fracture line 111 to a length that is easy to polish, wherein relatively little material remains. A typical length of rod 110 after this step is from 300 to 400 microns.

Following this step, rod 110 is reduced in length by polishing until only a thin plate remains, of the order of 20 to 100 microns in thickness.

FIG. 6C illustrates the results of the final step, in which a polishing or accurate cleaving operation reduces the remaining length of rod 110 (FIG. 6B) until there is formed a thin optical plate 112. Plate 112 protects the fragile capillaries of air cladding at end-face 104 from damage during polishing or cleaving and thereby plate 112 functions as a cap to seal the air-channels of air-clad optical fiber 50. Debris from the polishing process or cleaning liquid cannot enter into air channels and pores of cladding 56 (FIG. 4), because of the presence of optical plate 112 (FIG. 6). This is an example of tanning a capped air-clad optical fiber by a capping process to seal the airs-channels of the air-clad optical fiber.

Plate 112 remains permanently attached to fiber 50 (FIG. 5), thereby sealing the channels and pores of air cladding 56, and preventing humidity and other contamination from entering. According to the present invention, providing a similar plate at both end-faces of fiber 50 through a repetition of the above procedure at each end hermetically seals the internal air channels of cladding 56 and permanently prevents the degradation of fiber properties that otherwise occurs through the gradual introduction of humidity and other contaminants into the channels.

The material of the plate 112 may be selected according to the criterion that increasing of the refractive index of plate 112 allows extending the length, thereby relieving critical length tolerances.

A method of joining rod 108 to fiber 50 and fracturing rod 108 is disclosed in U.S. Pat. No. 6,014,483 to Thual et al. (hereinafter referred to as “Thual”). A microscope equipped with video camera and a viewing monitor enables manipulation of fiber 50 and rod 108 under visual control, making precise length measurements, and inspecting the splicing results. Following the splicing of rod 108 to fiber 50, rod 108 is cut to a length of about 400 microns.

In another exemplary embodiment of the present invention, protective plate 112 may be replaced by a specialize optical element, such as a Graded-Index (“GRIN”) fiber, from which lenses may be formed by polishing a GRIN fiber to a desired length. Thual teaches the principles of operation of such GRIN lenses and a method of controlling the path of optical radiation FIG. 8 is an illustration of an exemplary embodiment of the present invention showing air-clad fiber 50 with an attached GRIN lens 150 which has been polished to a suitable length to have light-collimating properties, as indicated by an optical path 152.

It is noted that while the present invention utilizes a method similar to that of Thual in attaching a rod to the end of a fiber, cutting the rod, and polishing the rod to a desired thickness, the present invention describes a completely new use for this attaching, cutting, and polishing. In Thual, the purpose of such a procedure is to obtain a desired optical coupling between the fiber and external devices by creating a lens in a rod having a graded index of refraction. In the present invention, the purpose of such a procedure is to eliminate the disadvantages of having open air channels in an air-clad or photonic-crystal fiber. Final does not teach such a use. Moreover, Thual does not teach an additional advantage to be gained by attaching, cutting, and polishing two such rods at both end-faces of the same fiber, nor does Thual teach the additional advantages of reducing power densities and facilitating the application of stable anti-reflective coatings. Furthermore, Thual teaches only the attachment of a graded-index fiber, whereas the present invention teaches that a glass or silica rod may also be attached, and provides criteria for selecting the (fixed) refractive index of such a rod. Finally, Thual teaches cutting and polishing an attached element to a length established by the need to significantly change the optical properties of the original fiber in a predetermined manner, whereas the present invention teaches cutting and polishing an attached element to as short a length as possible to avoid making any substantial change in the optical properties of the fiber.

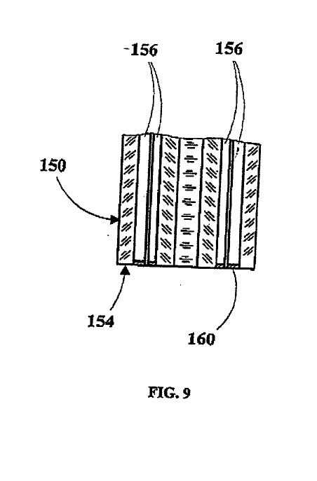

FIG. 9 illustrates yet another exemplary embodiment of the present invention, showing a simplified longitudinal cross section of an air-clad fiber 150 with an end-face 154, which is to be cleaved and polished. Air-clad fiber 150 features air channels 156. In accordance with the present invention, prior to polishing end-face 154, a material other tan glass or silica may seal air channels 156 of the air cladding. Sealing material 160 protects fragile air channels walls from damage in the course of the polishing process. Following the polishing, sealing material 160 remains in air channels 156 as a tin layer of proton from penetration by moisture and other impurities. There are a number of methods of sealing air channels 156, some exemplary methods of which are disclosed below.

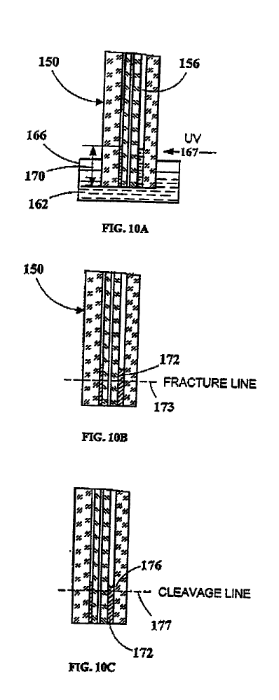

FIGS. 10A, 10B, and 10C are longitudinal cross-sections of a fiber illustrating steps in a method according to the present invention for fabricating a sealed end-face of an air-clad or photonic-crystal fiber by introducing a sealing material. Fluid is easier than solid material to introduce into porous structure. In order to deliver fluid material 16 into air channels 156, fiber 150 is immersed into a tank 166 containing a fluid 162. Fluid 162 is a UV-curable fluid, preferably glass-wetting, and may be a clear water-based varnish, such as manufactured by Coates Lorilleux Plc., Orpingon, Kent, UK or clear ink-jet printing ink such as the UV-curable Crystal UGE 0513, manufactured by Sunjet Plc., Midsomer, UK Capillary action draws fluid 162 into air-clad channels 156. There is no need to draw a large amount of fluid 162 into air channels 156. At a certain fluid height 170, as determined by subsequent processing (detailed below), further fluid penetration into fiber is prevented by exposing the fluid in air channels 156 to UV radiation. IV radiation cures and polymerizes the upper part of fluid 162 drawn into air clad channels 156. Fluid 162 becomes a solid polymer 172 (FIG. 10B). Energy levels required for polymer on are in the range of 300 mj/sq.cm., and are similar to those required for Bragg grating exposures. The rest of fluid 162 is polymerized by continuing exposure to UV radiation when fiber 150 is pulled out of fluid tank 166. Fluid 162, when cured into solid polymer 172, acts as material 160 (FIG. 9).

It some instances where capillaries of different diameters are used in air clad fiber manufacture the level of fluid 162 in air channels may be different. Fluid 162 will be drawn faster in narrow capillaries than in wider ones. In order to avoid this problem and maintain equal fluid height 170 in all capillaries, UV radiation is switched on concurrently with the immersion of fiber into fluid tank 166. UV radiation in this case cures fluid 162 immediately upon reaching the desired level. As noted above, curing the upper part of fluid 162 drawn into air clad channels 156 halts further penetration into air clad channels 156. This is an example of forming a filled and plugged air-clad optical fiber by a filling and plugging process to seal the air channels of the air-clad optical fiber.

It is necessary to mention that the height of fluid 162 in channels 156 of air-clad fiber 150 may be regulated by electro-capillary forces. The itensity of the electric field applied to the fluid and fiber is selected in such a way to ensures the desired height of fluid in air channels. This method is however more involved than the method detailed above that makes use of capillary action.

FIG. 10B illustrates a following step in which fiber 150 is at a fracture line 173 to a length that is easy to polish, wherein relatively little material 160 remains. A typical length of fiber area filled with sealing material after this step is from 300 to 400 microns.

Following this step, fiber 150 is reduced in length by polishing until only a thin area remains, of the order of 20 to 100 microns in thickness.

Polishing debris cannot penetrate into air channels 156 sealed by polymerized fluid 172. Polishing leaves, a minimal length of air-channel 156 filled with polymer 172. In this fashion, the filled length does not substantially affect the propagation and path of light within fiber 150.

Alternatively, if the end-face of fiber 150 does not require polishing (FIG. 10C) and cleaving is sufficient, fiber 150 may be cleaved under a microscope leaving a minimal amount of polymer 172 in air channels 156. For convenience, the microscope through which the cleaving process is observed may be equipped with a video camera. In cases where an edge 176 of clear polymer 172 is difficult to detect visually, a red or other dye-based UV-curable ink such as Crystal UPA 3558, manufactured by Sunjet Plc., Midsomer, UK, may be used.

Sealing polymer 172 remains permanently inside fiber 150, thereby sealing the channels and pores of air channels 156, to prevent humidity ad other contamination from entering. According to the present invention, sealing both end-faces of fiber 150 end hermetically seals the internal air channels of cladding 156 and permanently prevents the degradation of the fiber that otherwise occurs through the gradual introduction of humidity and other contaminants into the channels.

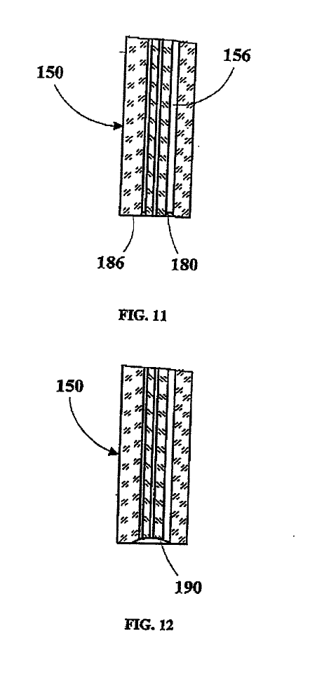

In a further exemplary embodiment sealing of channels 156 of air clad fiber 150 may be achieved by causing them to collapse and sealing them with material from the surrounding inner clad or capillary glass material. FIG. 11 is an illusion of this embodiment. Air channels 156 of air clad fiber 150 have been caused to collapse, thereby sealing air channels 156 with material 180 at an end-face 186.

Channels 156 may be caused to collapse by melting end face 186. For this purpose end face 186 is exposed to a source of suitable radiation which is absorbed by the material surrounding air channel 156. Electric arc-generated heat may be used to cause air channels 156 to collapse. The arc itself may be similar to that used for fiber fusion splicing. The length of the collapsed and sealed air channel may be regulated by selecting proper exposure time and laser power. This is an example of forming a sealed air-clad optical fiber by a constricting and collapsing process to constrict and collapse the air-channels of the air-clad optical fiber.

A CO₂ laser or excimer laser may alternatively be a sources of such radiation. The advantages of the laser use include delivery of intense energy over a smaller area and precise control of the energy deliver. Use of a laser can cause not only the desired collapse the channels but can also shape the inner clad and core into a desired form. FIG. 12 illustrates a convex region 190 in an end-face of fiber 150, formed in the manner described above, that both seals the air-channels and also effectively increases the numerical aperture of fiber 150. Region 190 is created partially by melting the fiber material as described above, and partially by ablating it.

There may be no need to polish the end-face of fiber with collapsed air clad channels. The thickness of tire layer of melted material in the laser-heated zone may be regulated by adjusting the time and power of heating and may be kept to a micron thickness of a few microns. A glass layer of this minimal thickness has practically no effect on the numerical aperture of fiber 150, and prevents contamination of the air channels and penetration of humidity therein.

The laser beam may be exposed directly onto end-face 186 of fiber 150, or alternatively onto an exposure mask, allowing selective processing of end-face 186.

While the invention has been described wit respect to a limited number of embodiments, it will be appreciated that many variations, modifications and other applications of the invention may be made.

1. An air-clad optical fiber having the air-channels of at least one end-face sealed in a manner selected from a group that includes being closed, being capped, being plugged, being filled, being constricted, and being collapsed.

2. A air-clad optical fiber having the air-channels at both end-faces sealed, such that the air-channels at each end-face are sealed in a manner selected from a group that includes being closed, being capped, being plugged being filled, being constricted, and being collapsed.

3. A method of sealing the air-channels at an end-face of an air-clad optical fiber, the method comprising the steps of:
(a) forming an end-face to be sealed by cleaving the air-clad optical fiber at a predetermined location;
(b) selecting a solid glass or silica fiber rod having a diameter comparable to that of the air-clad optical fiber,
(c) splicing said formed end-face of the air-clad optical fiber to said rod to form a spliced rod;
(d) cutting said spliced rod to a predetermined thickness suitable for polishing, such that said spliced rod has a flee end; and
(e) polishing said free end of said spliced rod to reduce said thickness such that the remaining material of said rod forms a cap that does not substantially affect the optical properties of the air-clad optical fiber regarding the light-coupling properties of the end-face of the air-clad optical fiber.

4. A method of sealing the air-channels at an end-face of an air-clad optical fiber, the method comprising the steps of:
(a) forming an end-face to be sealed by cleaving the air-clad optical fiber at a predetermined location;
(b) penetrating the air-channels of said end-face with a polymerizing fluid material;
(c) sealing the air-channels of said end-face by polymerizing said fluid that has penetrated therein;
(d) cutting the air-clad optical fiber to a predetermined size suitable for polishing; and
(e) polishing said sealed end-face of the air-clad optical fiber to reduce the thickness thereof such that the remaining material of the sealing does not substantially affect the optical properties of the air-clad optical fiber regarding the light-coupling properties of said sealed end-thee.

5. A method of sealing the air-channels at an end-face of an air-clad optical fiber, the method comprising the steps of:
(a) forming an end-face to be sealed by cleaving he air-clad optical fiber at a predetermined location;
(b) penetrating the air-channels of said end-face with a polymerizable fluid material;
(c) sealing the air-channels of said end-face by polymerizing the fluid that has penetrated therein; and
(d) cleaving the sealed free end of the air-clad optical fiber to a predetermined size to reduce the length thereof such that the remaining material of the sealing does not substantially affect the optical properties of the air-clad optical fiber regarding the light-coupling properties of the end-face.

6. A method of scaling the air-channels at an end-face of an air-clad optical fiber, the method comprising the steps of:
(a) forming an end-face to be sealed by cleaving the air-clad optical fiber at a predetermined location;
(b) melting said end-face by heating, and
(c) forming on said end-face a thin layer of melted fiber material to seal the air-channels of said end-face, in such a manner that the optical properties of the air-clad optical fiber regarding the light-coupling properties of the end-face are not substantially affected.
